(19) United States
(12) Patent Application Publication
(10) Pub. No.: US 2004/0128171 A1
(43) Pub. Date: Jul. 1, 2004

(54) Systems and methods for processing insurance information

(76) Inventors: Timothy E. Rees, Concord, VA (US); Mark R. Pollock, Charlotte, NC (US)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(21) Appl. No.: 10/331,460

(22) Filed: Dec. 31, 2002

(51) Int. Cl. G06F 17/60

(52) U.S. Cl. 705/4

(57) ABSTRACT

The invention includes systems and methods for providing insurance information from an insurance provider to a plurality of insurance agents disposed at respective insurance agent interface portions, the insurance agents working with respective clients. The system may include an insurance entity that is in the business of providing insurance, the insurance entity including an insurance tool; a first insurance agent interface portion, the insurance agent interface portion associated with a respective first insurance agent; a second insurance agent interface portion, the insurance agent interface portion associated with a respective second insurance agent; and a communication system that provides communication between the insurance tool and the insurance agent interface portion. The first insurance agent interface portion inputs insurance request information from the first insurance agent and forwards the insurance request information to the insurance tool over the communication system, and in response, the insurance tool outputs first customized insurance information to the first insurance agent interface portion over the communication system. The insurance tool generates the first customized insurance information based on dissecting internet address requests received from the first insurance agent interface portion. The system may also include a blocking portion to block undesired access by an agent.

### BACKGROUND OF THE INVENTION

The systems and methods of the invention relate to providing insurance related information and services to persons, such as agents and other authorized persons, working with an insurance provider.

In the insurance industry, one arrangement that is known includes a number of insurance agents or other authorized persons, who may or may not be affiliated with each other, interacting with an insurance provider. The insurance provider provides a wide variety of information and services to the insurance agent. Such information and services commonly include quote information and the fulfillment of insurance plans that are selected through the agent, for example. That is, an agent works with a client, of that agent, so as to procure a desired insurance plan for that client.

However, known systems and methods fail to address the need to effectively control, monitor and change the information that is exchanged between the insurance provider and the potentially thousands of agents, or other authorized person, that the insurance provider works with in the normal course of business.

Accordingly, the systems and methods of the invention address various shortcomings now present in known systems and methods.

### BRIEF SUMMARY OF THE INVENTION

In accordance with one aspect, the invention includes a system for providing insurance information from an insurance provider to a plurality of insurance agents disposed at respective insurance agent interface portions, the insurance agents working with respective clients, the system comprising an insurance entity that is in the business of providing insurance, the insurance entity including an insurance tool; a first insurance agent interface portion, the insurance agent interface portion associated with a respective first insurance agent; a second insurance agent interface portion, the insurance agent interface portion associated with a respective second insurance agent; and a communication system that provides communication between the insurance tool and the insurance agent interface portion; the first insurance agent interface portion inputs insurance request information from the first insurance agent and forwards the insurance request information to the insurance tool over the communication system, and in response, the insurance tool outputs first customized insurance information to the first insurance agent interface portion over the communication system; and wherein the insurance tool generates the first customized insurance information based on dissecting internet address requests received from the first insurance agent interface portion.

In accordance with a further aspect, the invention includes a system for providing insurance information from an insurance provider to a plurality of insurance agents disposed at respective insurance agent interface portions, the insurance agents working with respective clients, the system comprising an insurance entity that is in the business of providing insurance, the insurance entity including an insurance tool; a first insurance agent interface portion, the insurance agent interface portion associated with a respective first insurance agent; a second insurance agent interface portion, the insurance agent interface portion associated with a respective second insurance agent; and a communication system that provides communication between the insurance tool and the insurance agent interface portion; the first insurance agent interface portion inputs insurance request information from the first agent and forwards the insurance request information to the insurance tool over the communication system, and in response, the insurance tool outputs first customized insurance information to the first insurance agent interface portion over the communication system; and wherein the insurance tool includes a blocking portion, the blocking portion performing a blocking process on the insurance request information received from the first insurance agent interface portion, the blocking process comparing data in the insurance request information with data in a blocking database associated with the insurance tool, the insurance tool terminating securement of an insurance plan by the first insurance agent interface portion if a match is determined.

In accordance with a further aspect, the invention includes a system for providing insurance information from an insurance provider to a plurality of insurance agents disposed at respective insurance agent interface portions, the insurance agents working with respective clients, the system comprising an insurance entity that is in the business of providing insurance, the insurance entity including an insurance tool; a first insurance agent interface portion, the insurance agent interface portion associated with a respective first insurance agent; a second insurance agent interface portion, the insurance agent interface portion associated with a respective second insurance agent; and a communication system that provides communication between the insurance tool and the insurance agent interface portion; the first insurance agent interface portion inputs insurance request information from the first agent and forwards the insurance request information to the insurance tool over the communication system, and in response, the insurance tool outputs first customized insurance information to the first insurance agent interface portion over the communication system; and wherein the insurance tool generates the first customized insurance information based on dissecting internet address requests received from the first insurance agent interface portion; and wherein the insurance tool includes a blocking portion, the blocking portion performing a blocking process on the insurance request information received from the first insurance agent interface portion, the blocking process comparing data in the insurance request information with data in a blocking database associated with the insurance tool, the insurance tool terminating securement of an insurance plan by the first insurance agent interface portion if a match is determined.

In accordance with a further aspect, the invention includes a method for providing insurance information from an insurance provider to a plurality of insurance agents disposed at respective insurance agent interface portions, the insurance agents working with respective clients, the method comprising providing an insurance entity that is in the business of providing insurance, the insurance entity including an insurance tool; providing a first insurance agent interface portion, the insurance agent interface portion associated with a respective first insurance agent; providing a second insurance agent interface portion, the insurance agent interface portion associated with a respective second insurance agent; and providing a communication system that provides communication between the insurance tool and the first insurance agent interface portion; inputting, by the first insurance agent interface portion, insurance request information from the first agent; forwarding the insurance request information to the insurance tool over the communication system using an internet address request, and in response; outputting, by the insurance tool, first customized insurance information to the first insurance agent interface portion over the communication system; and wherein the insurance tool generates the first customized insurance information based on dissecting the internet address request received from the first insurance agent interface portion.

In accordance with a yet further aspect, the invention includes a method for providing insurance information from an insurance provider to a plurality of insurance agents disposed at respective insurance agent interface portions, the insurance agents working with respective clients, the method comprising providing an insurance entity that is in the business of providing insurance, the insurance entity including an insurance tool; providing a first insurance agent interface portion, the insurance agent interface portion associated with a respective first insurance agent; providing a second insurance agent interface portion, the insurance agent interface portion associated with a respective second insurance agent; and providing a communication system that provides communication between the insurance tool and the first insurance agent interface portion; inputting, by the first insurance agent interface portion, insurance request information from the first insurance agent; forwarding the insurance request information to the insurance tool over the communication system using an internet address request, and in response; outputting, by the insurance tool, first customized insurance information to the first insurance agent interface portion over the communication system; and wherein the insurance tool generates the first customized insurance information based on dissecting the internet address request received from the first insurance agent interface portion; and; comparing data in the insurance request information with data in a blocking database associated with the insurance tool; and terminating securement of an insurance plan by the first insurance agent interface portion if a match is determined between data in the insurance request information and data in a blocking database.

### BRIEF DESCRIPTION OF THE DRAWINGS

The present invention can be more fully understood by reading the following detailed description together with the accompanying drawing, in which like reference indicators are used to designate like elements, and in which:

FIG. 1 is a block diagram showing a processing system in accordance with one embodiment of the invention;

FIG. 2 is a block diagram showing further details of the insurance entity of FIG. 1 in accordance with one embodiment of the invention;

FIG. 3 is a flowchart showing an “Agent initiates interaction with insurance tool” process in accordance with one embodiment of the invention;

FIG. 4 is a flowchart showing the “Unverified agent interfaces with the insurance tool” step of FIG. 3 in further detail in accordance with one embodiment of the invention;

FIG. 5 is a flowchart showing a “Verified agent interfaces with the insurance tool” step of FIGS. 3 and 4 in further detail in accordance with one embodiment of the invention;

FIG. 6 is a flowchart showing a “Verified agent interacts with insurance tool to complete application” step of FIG. 5 in further detail in accordance with one embodiment of the invention;

FIG. 7 is a flowchart showing an “Administrator user interfaces with the insurance tool” process in accordance with one embodiment of the invention;

FIG. 8 is a flowchart showing the “General administrator interacts with insurance tool” and the “Super administrator interacts with insurance tool” steps of FIG. 7 in further detail in accordance with one embodiment of the invention;

FIG. 9 is a flowchart showing the “Perform super administrator menu selections” step of FIG. 8 in further detail in accordance with one embodiment of the invention;

FIG. 10 is a flowchart showing a “Blocking portion performs processing” process in accordance with one embodiment of the invention;

FIG. 11 is a flowchart showing a “URL processing portion generates web page and outputs to web server” process in accordance with one embodiment of the invention;

FIG. 12 is a flowchart showing the “Assemble web page data based on respective string sets” step of FIG. 11 in further detail in accordance with one embodiment of the invention;

FIG. 13 is a diagram showing the dissection of a URL (universal resource locator) in accordance with one embodiment of the invention; and

FIG. 14 is a screen shot diagram in accordance with one embodiment of the invention.

### DETAILED DESCRIPTION OF THE INVENTION

Hereinafter, aspects of the insurance processing system in accordance with various embodiments of the invention will be described. As used herein, any term in the singular may be interpreted to be in the plural, and alternatively, any term in the plural may be interpreted to be in the singular.

The systems and methods of the invention are directed to the above stated problems, as well as other problems, that are present in conventional techniques. The foregoing description relating to various products, methods, and/or apparatus and their attendant disadvantages described in the “Background of the Invention” is in no way intended to limit the scope of the invention, or to imply that the invention does not include some or all of the various elements of known products, methods, and/or apparatus in one form or another. Indeed, various embodiments of the invention may be capable of overcoming some of the disadvantages noted in the “Background of the Invention,” while still retaining some or all of the various elements of known products, methods, and apparatus in one form or another.

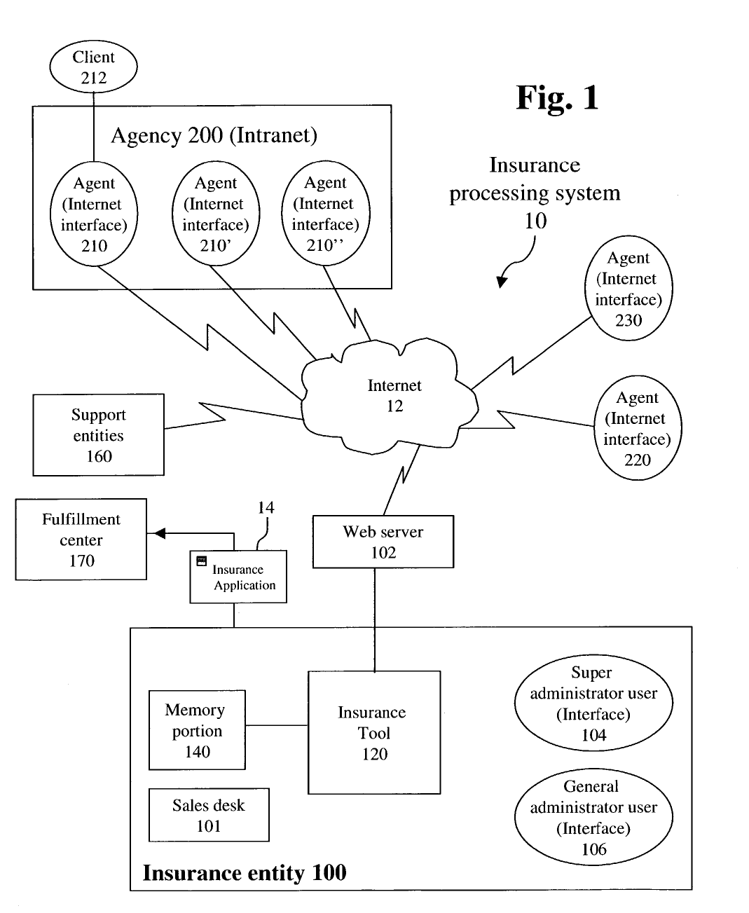

FIG. 1 is a block diagram showing an insurance processing system 10 in accordance with one embodiment of the invention. The insurance processing system 10 might be used to process term life insurance, as well as other types of insurance. The insurance processing system 10 includes an insurance entity 100. The insurance entity 100 interacts with a variety of agents (210, 220, 230). In turn these agents interact with clients 212 who wish to secure insurance from the agents. Typically, the interaction between an agent 210, for example, and the client 212 is in a face-to-face situation. As used herein, an “insurance agent” means any person who is authorized to work with clients of that insurance agent on a one to one basis. Further, the insurance entity 100 may be any entity that can interact with the insurance agent so as to provide insurance as described herein, i.e., the insurance entity 100 is an insurance provider. The interaction of the agents, such as the agent 210, with the insurance entity 100 might be through a suitable web browser, such as Microsoft Corporation's INTERNET EXPLORER, for example.

As shown in FIG. 1, the insurance agents (210, 220, 230) may be sole practitioners (220,230), or alternatively disposed in an agency 200 as shown by insurance agents 210. Further, while the systems and methods of the invention are illustratively discussed herein as including an agency 200, it is of course appreciated that the insurance entity 100 may interact with any other entity, such as a firm or a company, who is in the business of working with clients to secure insurance. Hereinafter, aspects relating to the agent 210 will be described. However, the agents (210′, 210″, 220, 230) may also interact in the insurance processing system 210 in a similar manner as the agent 210. As shown in FIG. 1, the agent 212 interfaces with the insurance entity 100 over the Internet 12 via a web server 102. The agent 212 may directly interface with an intranet maintained by the agency 200, the intranet in turn interfacing with the insurance tool 120, in accordance with one embodiment of the invention.

The insurance processing system 10 further includes support entities 160 and a fulfillment center 170. The support entities 160 may be a wide variety of entities that provide support or services to the insurance entity 100. The fulfillment center 170 actively works with the insurance entity 100 to fulfill insurance requests to clients 212. That is, once a client 212, working through an agent 210, completes an insurance application as described in detail below, the insurance application is forwarded to the fulfillment center 170. For example, the insurance application might be forwarded to the fulfillment center 170 by mail 14, in accordance with one embodiment of the invention. Further details of the fulfillment center 170 are described below.

As shown in FIG. 1, the insurance entity 100 includes an insurance tool 120 and a memory portion 140. Further details of these components are described in detail below. The insurance entity 100 also includes what may be characterized as a super administrator user 104, i.e., a human person. The super administrator user 104 interfaces with the insurance entity 100 through a suitable interface, such as via a computer terminal connected to the network of the insurance entity 100, in accordance with one embodiment of the invention. Similarly, the insurance entity 100 includes a general administrator user 106. The general administrator user 106 also interfaces with the insurance entity 100 in a suitable manner, such as through a suitable user interface.

Also, the insurance entity 100 includes what may be characterized as a “sales desk” 101. The sales desk 101 may be manned by persons or in some way automated to provide support to the agents that work with the insurance entity 100 via the insurance tool 120.

The insurance tool 120 in the insurance entity 100 performs a wide variety of tasks so as to work with an agent 210 to (1) provide quotes to that agent 210; and (2) to secure an insurance application for a client 212 of the agent 210. Further, the memory portion 140 in the insurance entity 100 stores a variety of information that is used by the insurance tool 120, as described in detail below.

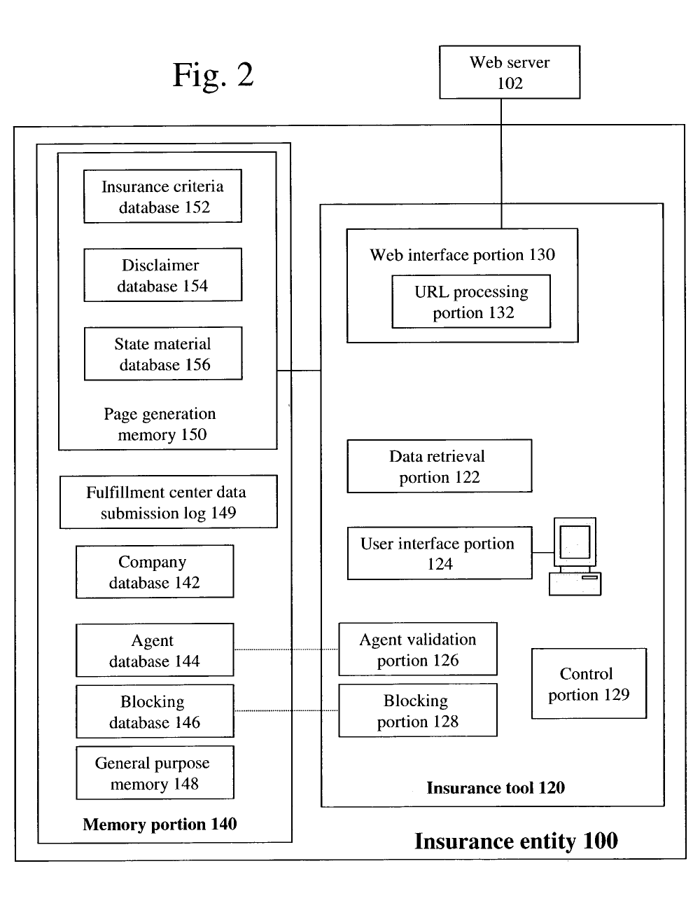

FIG. 2 is a block diagram showing further details of the insurance entity 100 of FIG. 1 in accordance with one embodiment of the invention. As shown in FIG. 2, the insurance entity 100 includes the insurance tool 120. The insurance tool 120 includes a web interface portion 130 for interfacing with the web server 102. The web interface portion 130 includes a URL processing portion 132. The URL processing portion 132 inputs URLs that are received by an agent 210, dissects the URLs, and prepares web pages for output to the requesting agent 210.

The insurance tool 120 further includes a user interface portion 124. The user interface portion 124 provides access to the insurance tool 120 by a super administrator user 104 and/or a general administrator user 106, in accordance with one embodiment of the invention.

The insurance tool 120 further includes a data retrieval portion 122. The data retrieval portion 122 is responsible for the retrieval of data from the memory portion 140, for example, not otherwise handled by other operating components in the insurance tool 120. Illustratively, the data retrieval portion 122 might operate with the URL processing portion 132 or the agent validation portion 126, described below, for example.

The insurance tool 120 also includes an agent validation portion 126. The agent validation portion 126 performs processing associated with the validation of an agent 210, in accordance with one embodiment of the invention. The agent validation portion 126, with the assistance of the data retrieval portion 122, uses agent information in the agent database 144, as shown in FIG. 2.

The insurance tool 120 also includes a blocking portion 128. The blocking portion 128 performs processing associated with blocking undesirable attempted access to the insurance entity 100, in accordance with one embodiment of the invention, as is described below. The blocking database 146, with the assistance of the data retrieval portion 122, uses blocking information in the blocking database 146, as shown in FIG. 2. The blocking information may be any of a wide variety of criteria, as desired, such as an agent tax identification number, for example.

The insurance tool 120 also includes a control portion 129. The control portion 129 controls the various processing of the insurance tool 120 not otherwise controlled. For example, the control portion 129 might control load processing and/or data recovery operations in the insurance tool 120, as well as a wide variety of other operations.

As shown in FIG. 2, the insurance entity 100 further includes the memory portion 140. The memory portion 140 includes the agent database 144 and the blocking database 146, as noted above. The memory portion 140 also includes a company database 142. The company database 142 contains data regarding the various companies, i.e., agencies 200 for example, that are authorized to do business with the insurance entity 100.

The memory portion 140 also contains a page generation memory 150. The page generation memory 150 includes an insurance criteria database 152, a disclaimer database 154, and a state material database 156, in accordance with one embodiment of the invention. However, the page generation memory 150 might also contain other types of data and/or memory portions, as desired. The data contained in the page generation memory 150, in accordance with one embodiment of the invention, is used to generate web pages via which the insurance tool 120 inputs and receives data. However, it should be further appreciated that the data in the page generation memory 150 may also used for other purposes, i.e., such as by a super administrator user 104 checking on the requirements of a particular state (VA, PA, etc.).

The memory portion 140 further includes a general purpose memory 148. The general purpose memory 148 stores a wide variety of data not otherwise stored in the memory portion 140. For example, the general purpose memory 148 might store programs used by the insurance tool 120, in accordance with one embodiment of the invention. Also, the memory portion 140 includes a “fulfillment center data submission log” memory 149. The “fulfillment center data submission log” memory 149 retains data associated with submissions to the fulfillment center 170, in accordance with one embodiment of the invention.

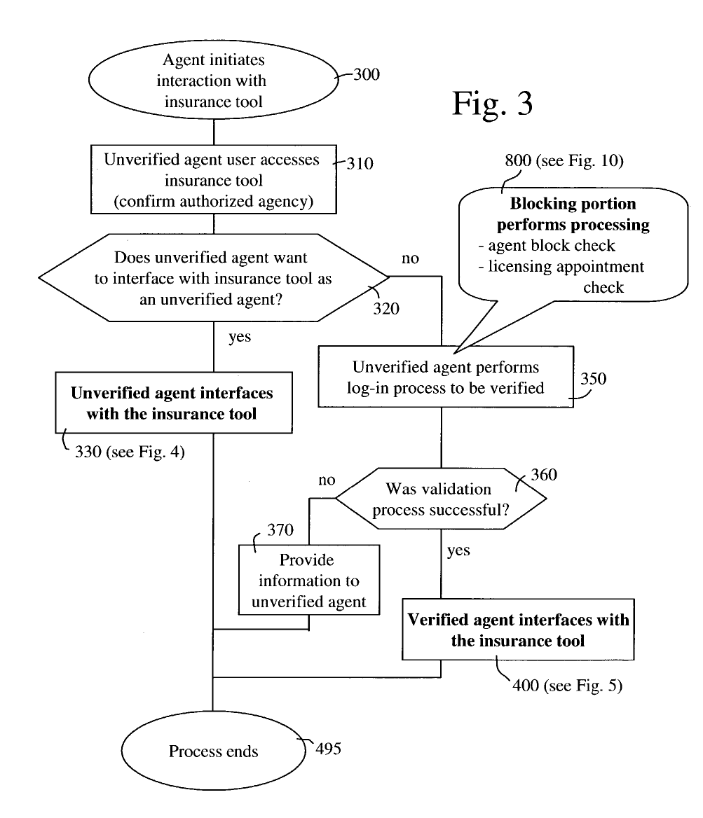

Hereinafter further aspects of the invention will be described with reference to FIG. 3. FIG. 3 is a flowchart showing an “agent initiates interaction with insurance tool” process in accordance with one embodiment of the invention. For example, the agent 210 in the agency 200 might be working with a client 212. The agent 210 may want to obtain a variety of quotes from the insurance entity 100, as well as to secure a policy for the client based on the quotes that the agent reviews. As shown in FIG. 3, the process starts in step 300, and passes to step 310.

In step 310 the unverified agent user accesses the insurance tool. In accordance with one embodiment of the invention, the actual identity of the agent is not determined in step 310. Rather, the insurance tool 120 merely identifies and confirms that the agent user is associated with an authorized agency. That is, the agent 210 has initially not logged on, but may still obtain various quote information. To explain, an agent can obtain quotes without logging in, but can go no further without verifying the agent's identity. Once an agent chooses to proceed with log-in so as to secure a plan, various operations are performed. For example, licensing restrictions in some states prohibit solicitation prior to appointment with the specific carrier for whom the product is being sold. As a result, the systems and methods of the invention, as described below, perform both a licensing appointment check and agent block check prior to allowing an agent to go past merely obtaining quote information. This ensures that the agent is both a valid and wanted user on the system.

To explain further with reference to FIG. 3, after step 310, the process passes to step 320. In step 320 the process determines if the unverified agent wants to interface with the insurance tool 120 as an unverified agent, i.e., so as to not log-in. For example, if the agent knows that he or she only wants to obtain quotes in a session, that agent may not want to log in.

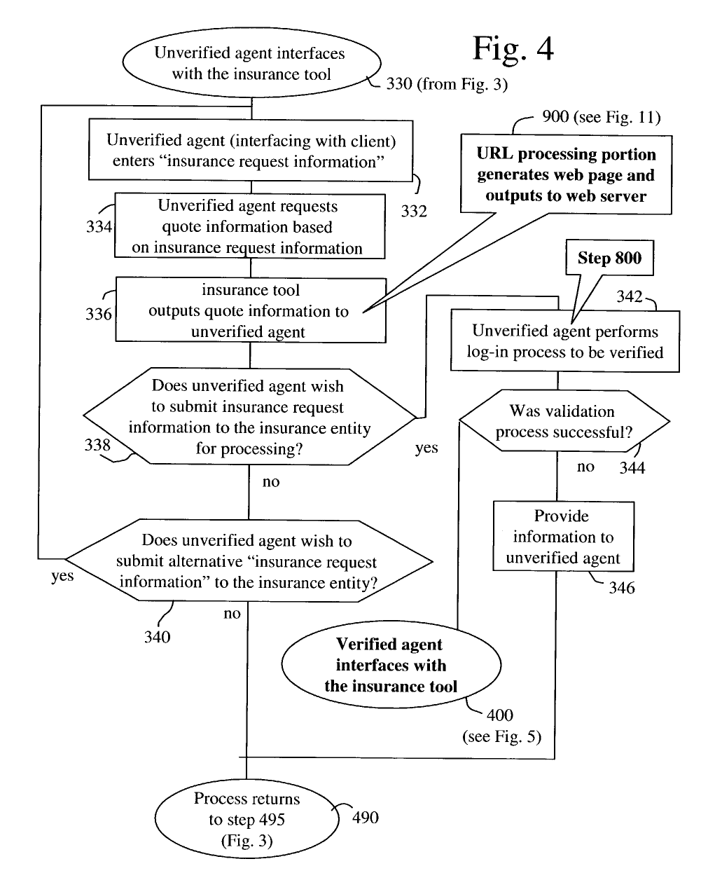

If the agent, whose associated agency has been verified in step 310, does not want to log-in, i.e., if yes in step 320, the process passes to step 330. In step 330 the unverified agent interfaces with the insurance tool to obtain quotes. Further details of step 330 are shown in FIG. 4.

Alternatively, the agent 210 may want to log-in. As a result, the process passes from step 320 to step 350. In step 350 the unverified agent performs a log-in process to be verified. Then, in step 360 the process determines whether the validation process was successful. In accordance with one embodiment of the invention, the agent validation portion 126 compares the agent information with the information stored in the agent database 144.

If the validation process was not successful in step 360, then the process passes to step 370. In step 370 the process provides information to the unverified agent regarding why the log-in was unsuccessful. Further, a variety of other information might be provided to the particular user, such as how to register with the insurance entity 100, for example.

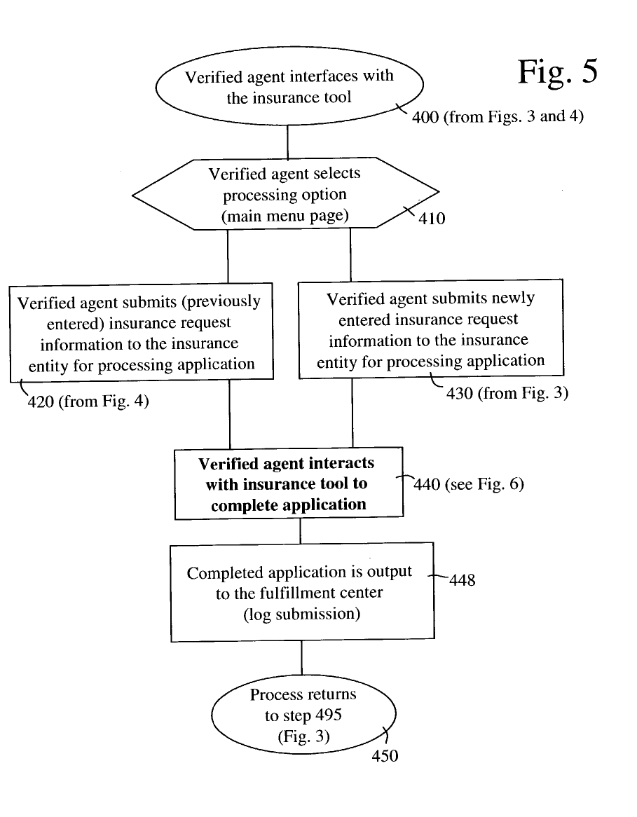

Alternatively, the validation in step 360 may have been successful. As a result, the process passes to step 400 in which the verified agent interfaces with the insurance tool. Further details of step 400 are shown in FIG. 5. Then, in step 495 the process ends.

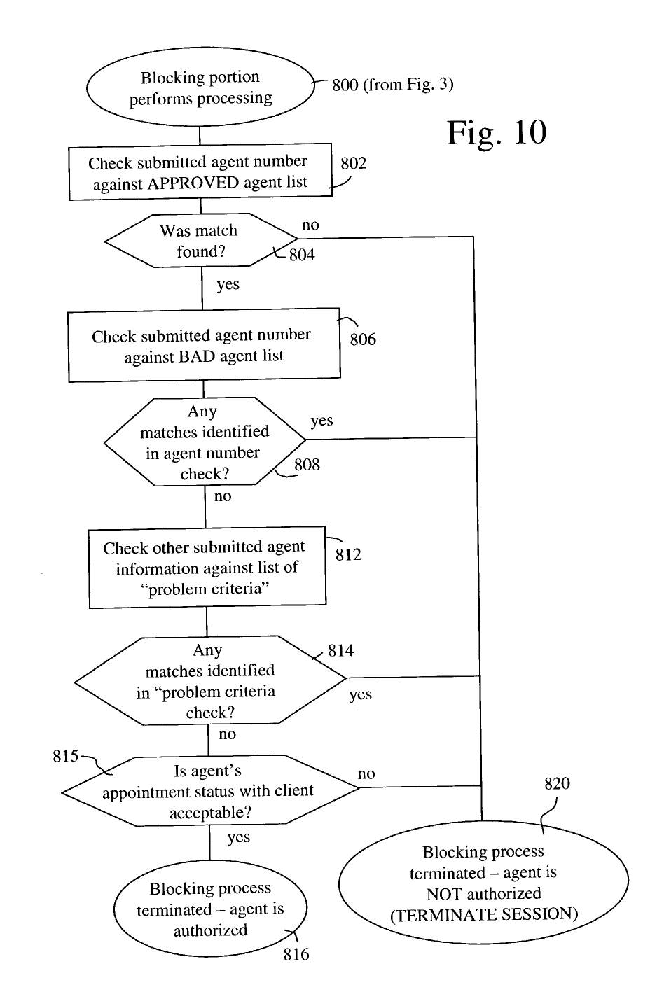

The process of FIG. 3 also includes step 800, which is associated with the log-in process. That is, in conjunction with the agent log-in, the blocking portion 128 performs a check on the particulars of the agent. FIG. 10, as described below, shows further aspects of the blocking portion performs processing.

FIG. 4 is a flowchart showing the “unverified agent interfaces with the insurance tool” step 330 of FIG. 3 in further detail in accordance with one embodiment of the invention. That is, the process of FIG. 4 shows activities of an agent before the agent performs a validation process. At this point in the process, the agent's 210 associated agency 200 may typically be verified, but not the identity of the particular agent of that agency. In the situation of sole practitioners, or other agents that are not associated with an agency, some type of general verification may be performed on the identity of the agent, for example.

As shown in FIG. 3, the process starts in step 330 and passes to step 332. In step 332, the unverified agent, typically sitting in the agent's office with the client, enters “insurance request information.” The insurance request information might include the name of the client, age, social security number, address, and health information, as well as a wide variety of other information that will typically depend in the type of insurance sought. Then, in step 334, the unverified agent requests “quote information” from the insurance entity 100, i.e., based on “insurance request information” that the agent has entered.

Then, in step 336 the insurance tool 120 outputs responsive quote information to unverified agent. The agent then reviews the quote information to see if the particular package is indeed something that the client would like. In accordance with one embodiment of the invention, the agent 210 may be provided with multiple quotes from the insurance tool 120, i.e., by which the agent may make comparisons.

After step 336, in step 338, the process queries whether the unverified agent wishes to submit the previously entered “insurance request information” to the insurance entity 100 for processing, i.e., so that the insurance tool 120 would actually generate a confirmation of receipt of the insurance request information for the selected plan by the insurance entity or its proxy. Accordingly, the systems and methods of the invention allow the agent to convert data that was entered for exploratory purpose to data that will formally be submitted for processing by the insurance entity 100. That is, if yes in step 338, the process passes to step 342.

At this point in the process, the agent 210 is going beyond merely obtaining quote information and moving towards formally submitting the insurance request information for the securement of a plan from the insurance entity 100. Accordingly, in a manner similar to that described above, in step 342 the unverified agent performs a log-in process to be verified. The processing of step 342 may also utilize the blocking processing, as described above with reference to step 350 of FIG. 3. In step 344 the process determines if the validation process associated with the agent log-in was successful. If no, then in step 346, the process provides information to unverified agent, i.e., regarding why the log-in process failed, for example.

Alternatively, if yes in step 344, the process passes to step 400, in which the verified agent interfaces with the insurance tool. However, in contrast to the agent's access to step 400 in FIG. 3, in FIG. 4, the agent has already entered the insurance request information by which a plan might be secured. FIG. 5 shows further details of step 400 of FIG. 4.

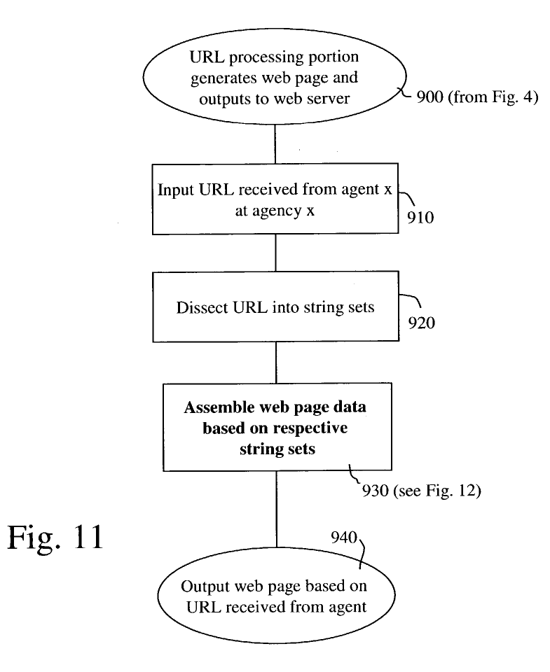

As shown in FIG. 4, the process step 336 is associated with a processing step 900. In step 900 the URL processing portion 132 in the insurance tool 120 generates a web page and outputs to web server. That is, the generation of the web page that the particular agent 210 views is typically custom tailored to the agent 210 and/or the particular agency 200 to which the agent 210 is associated. Further details of the operations of the URL processing portion 132 and step 900 are described below with reference to FIG. 11. The customized web page and processing of the URL processing portion 132 may be used with any web page presented to an agent by the insurance tool 120.

Returning now to step 338 of FIG. 4, the agent 210 may alternatively determine that a particular quote is not acceptable to the client 212. Accordingly, in step 338 the agent may not wish to formally submit the insurance request information. The process then passes to step 340. In step 340, the process asks whether the unverified agent wishes to submit alternative “insurance request information” to the insurance entity, i.e., does the agent wish to explore further quotes? This alternative “insurance request information” might involve different plan details or a completely different plan altogether, for example. If yes in step 340, the process returns to step 332 and continues as described above.

Alternatively, if no in step 340, the process passes to step 490. In step 490 process returns to step 495 of FIG. 3, as noted above, and ends for that particular session of the agent.

FIG. 5 is a flowchart showing further details of the “verified agent interfaces with the insurance tool” step of FIGS. 3 and 4 in accordance with one embodiment of the invention. As shown in FIG. 5, the sub-process starts in step 400 and passes to step 410. In step 410 the verified agent selects a processing option from a main menu page, for example, that is presented to the user over the Internet by the insurance tool 120. The two options that are presented to the agent 210 are shown in steps (420, 430), in accordance with one embodiment of the invention.

In step 420 the verified agent submits previously entered insurance request information to the insurance entity for processing an application request. This is, step 420 of FIG. 5 reflects the situation where the agent 210 is using insurance request information that was previously used in an exploratory quote (while the agent was working as an unverified agent), i.e., as shown in FIG. 4. Alternatively, in step 430 the verified agent submits newly entered insurance request information to the insurance entity for processing an application. After either of steps (420, 430) the process passes to step 440.

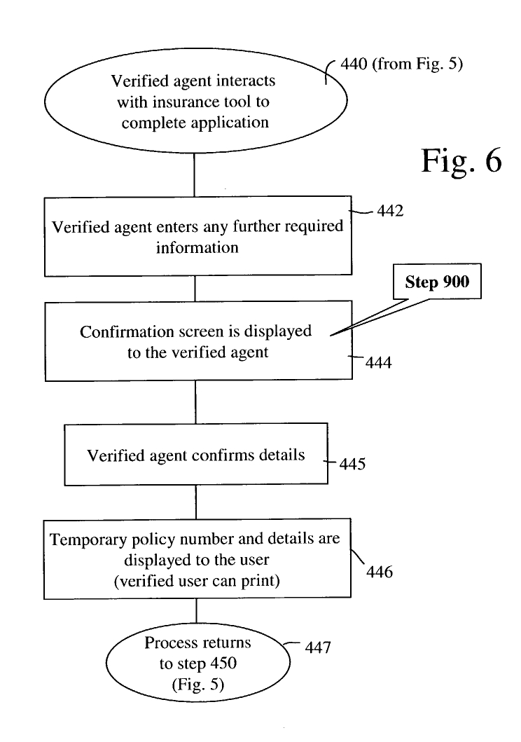

In step 440 the verified agent interacts with the insurance tool to complete the application. Further details of step 440 are shown in FIG. 6, After step 440, the process passes to step 448. In step 448, the completed application is forwarded or in some manner output to the fulfillment center 170. This output to the fulfillment center 170 is then logged by the insurance tool 120. For example, the insurance tool 120 might log the output to the fulfillment center data submission log memory 149, as shown in FIG. 2. Accordingly, a constant log is maintained of data output to the fulfillment center 170. This log might be accessed by an administrator in the insurance entity 100, or alternatively, accessed by persons in a respective agency 200 in some suitable manner, for example, so as to monitor activities of their agents.

That is, once application information is received from an agent by the insurance entity 100, the application information might also be output to the agency 200 at which the particular agent 210 works. This allows an agency 200 to monitor activities of its agents. This information output to an agency might be done in an automated fashion, as is desired. It should of course be appreciated that information to the fulfillment center 170 and/or an agency 200, or some other entity, may be encrypted, as is desired.

After step 448 of FIG. 5, the process passes to step 450. In step 450 the process returns to step 495 of FIG. 3.

FIG. 6 is a flowchart showing the “verified agent interacts with insurance tool to complete application” step 440 of FIG. 5 in further detail, in accordance with one embodiment of the invention. The process of FIG. 6 starts in step 440 and passes to step 442. In step 442 the verified agent enters any further required information that might be required for the further processing of an insurance application. Then, in step 444 a confirmation screen is displayed to the verified agent. In step 445 the verified agent confirms the details of the particular insurance package that was selected. Then, in step 446 a temporary policy number and details are displayed to the agent, i.e., such that the agent 210 might print the details and provide a copy to the client 212, for example. Any of a variety of other information may also be provided to the client 212 and/or the agent 210. Then in step 447 the process returns to step 448 of FIG. 5.

In accordance with one embodiment of the invention, the activities of an agent 210 are described above. However, further persons that interact with the insurance entity 100 are the administrators of the insurance entity 100. As shown in FIG. 1, these administrators might include a super administrator user 104 and a general administrator user 106, in accordance with one embodiment of the invention. A super administrator user 104 typically possesses greater responsibility and access as compared to a general administrator user 106.

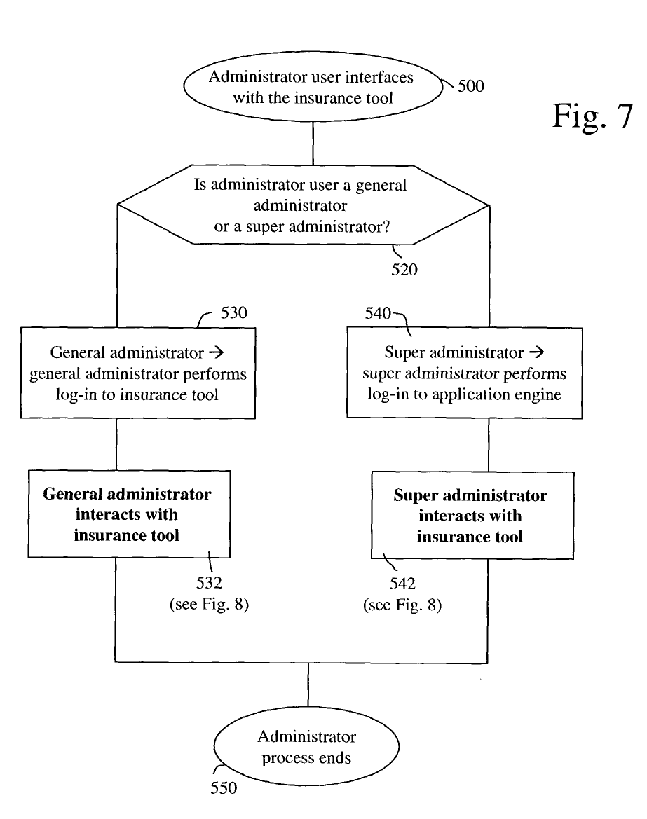

FIG. 7 is a flowchart showing a process associated with activities of an administrator. More specifically, FIG. 7 shows an “administrator user interfaces with the insurance tool” process in accordance with one embodiment of the invention. The process of FIG. 7 starts in step 500 and passes to step 520.

In step 520, the process determines whether the particular administrator accessing the insurance tool 120 is a general administrator or a super administrator using a suitable procedure. That is, the process passes to step 530 or 540 depending on whether the user is a super administrator user 104 or a general administrator user 106.

If the user is a general administrator, the process passes to step 530. In step 530, the general administrator performs log-in to the insurance tool 120. In contrast, in step 540 the super administrator performs log-in to the insurance tool 120.

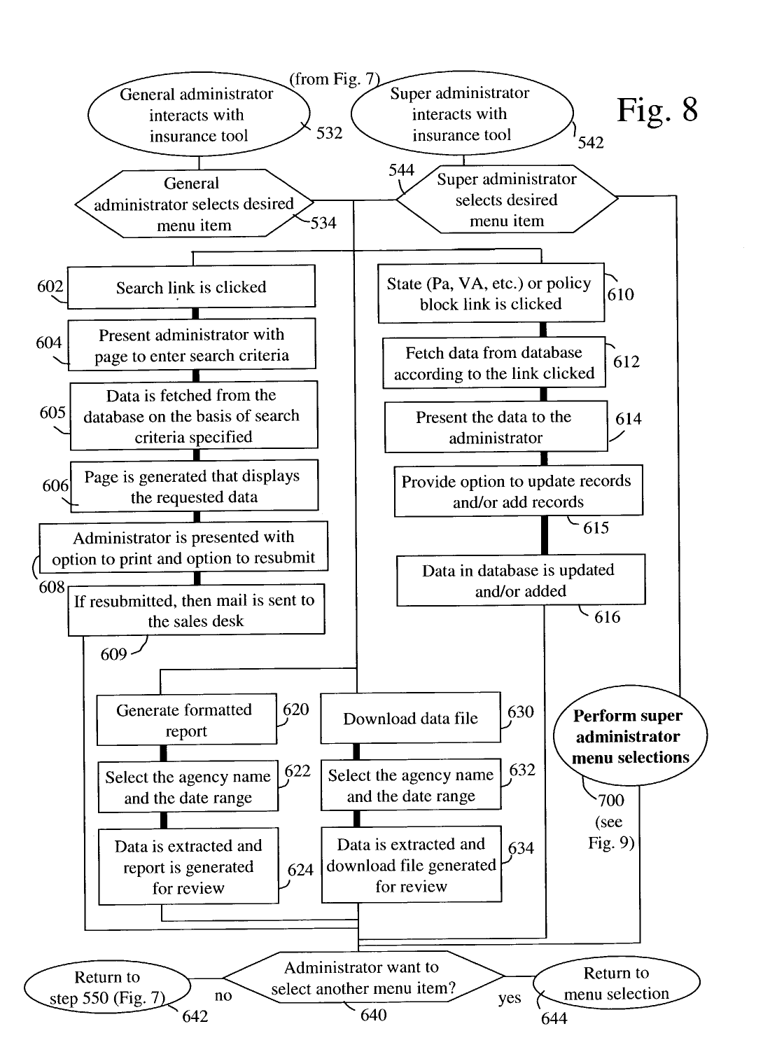

As shown in FIG. 7, the process passes from step 530 to step 532 if dealing with a general administrator. In step 532, the general administrator interacts with insurance tool 120. Alternatively, if dealing with a super administrator, the process passes from step 540 to step 542. In step 542, the super administrator interacts with insurance tool. Further features of both steps 532 and 542 are shown in FIG. 8. The process of FIG. 7 passes from both steps 532 and 542 to step 550. In step 550 the administrator process ends.

FIG. 8 is a flowchart showing the “general administrator interacts with insurance tool” and the “Super administrator interacts with insurance tool” steps of FIG. 7 in further detail in accordance with one embodiment of the invention. To explain, FIG. 8 shows that the super administrator user 104 and the general administrator user 106 both can access a variety of features provided by the insurance tool 120. However, as reflected in step 700 of FIG. 8, the super administrator user 104 has greater access than the general administrator user 106.

The process of FIG. 8 for the general administrator user 106 starts in step 532 in which the general administrator interacts with insurance tool. Then, in step 534 the general administrator selects a desired menu item. Alternatively, for the super administrator, the process passes from step 542 to step 544 in which the super administrator selects desired menu item. These menu options illustratively include any of the options of steps (602, 610, 620 and 630) for both the super administrator user 104 and the general administrator user 106, in accordance with one embodiment of the invention. Further, the super administrator user 104 is presented with the options of step 700 of FIG. 8, i.e., in which the super administrator user 104 can access super administrator menu options.

In accordance with one menu option, in step 602 the search link is clicked by the administrator. In step 604 the administrator is presented with a web page to enter search criteria by the insurance tool 120. Then, in step 605 the data is fetched from the database on the basis of the search criteria specified. This processing might be performed by the data retrieval portion 122, in accordance with one embodiment of the invention. In step 606 the page is generated by the insurance tool 120 that displays the requested data. In step 608 the administrator is presented with option to print and the option to “resubmit.” In step 609 if resubmitted, then mail is sent to the sales desk 101 in the insurance entity 100, in accordance with one embodiment of the invention, for example.

In accordance with a further menu option, in step 610, the State (Pa, VA, etc.) or policy block link is clicked by the administrator. In step 612 the process fetches data from database according to the link clicked, i.e., such as from the insurance criteria database 152, the disclaimer database 154 and/or the state material database 156, for example. In step 614, the data is presented to the administrator. Then in step 615, the administrator is presented with the option to update records and/or add records. In step 616 the data in database is updated and/or added, if desired.

In accordance with a further menu option, in step 620 the administrator may generate a formatted report. Illustratively, in step 622 the administrator selects the agency name, the agency 200, and a date range, for example. In step 624 data is extracted and report is generated for review. Any of a wide variety of search options may be presented to the user.

In accordance with a yet further menu option, in step 630 the administrator requests to download a data file. Accordingly, in step 632, the administrator selects the agency name and the date range. In step 634 the data is extracted and the downloaded file generated for review.

After an administrator user accesses and performs a menu option as shown in FIG. 8, the process passes to step 640. In step 640 the administrator determines if they want to select another menu item. If no, then the process passes to step 642 and then returns to step 550 of FIG. 7. Alternatively, in step 640, the administrator user may determine that she does indeed want a further menu selection. Accordingly, the process returns to a desired menu selection, as reflected in step 644 of FIG. 8.

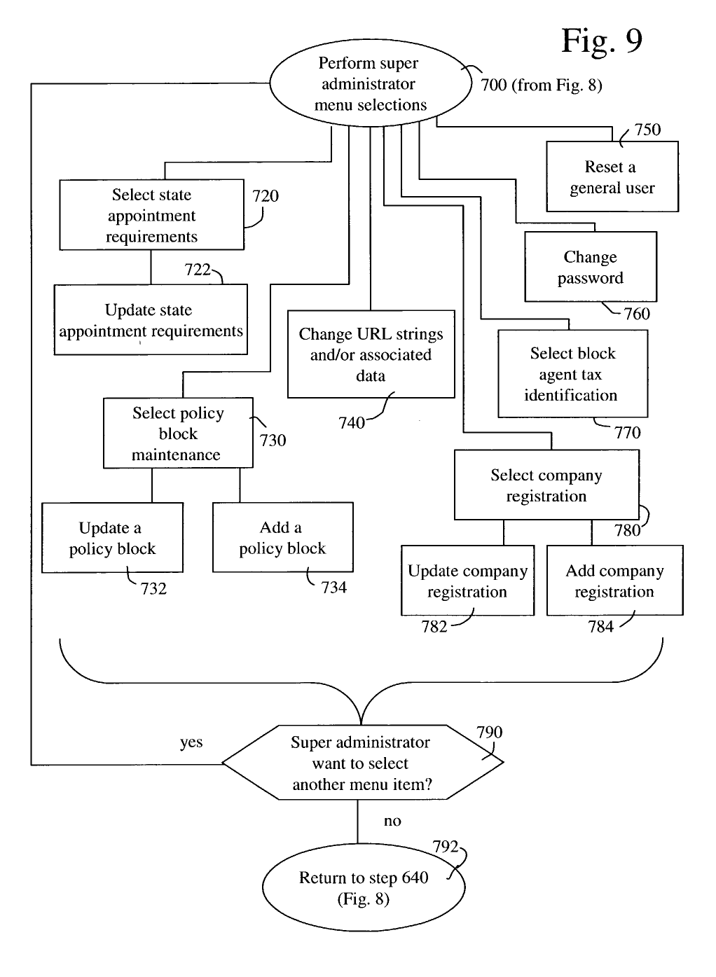

FIG. 9 is a flowchart showing the “perform super administrator menu selections” step of FIG. 8 in further detail in accordance with one embodiment of the invention. The sub-process of FIG. 9 starts in step 700 and passes to a desired menu option (720, 730, 740, 750, 760, 770, an/or 780), as requested by a super administrator user 104.

In step 720, for example, the super administrator user may select state appointment requirements. The process passes from step 720 to step 722 in which the super administrator user 104 updates the state appointment requirements.

In accordance with a further menu option, in step 730 the super administrator user may select “policy block maintenance.” Then in step 732 the super administrator user 104 may update a policy block. Alternatively, in step 734 the super administrator user 104 may add a policy block.

In accordance with a further menu option, in step 740 the super administrator user may change URL strings and/or associated data. In accordance with a yet further menu option, in step 750 the super administrator user may reset a general user. As a further menu option, in step 760 the super administrator user may change a password. As a further menu option, in step 770 the super administrator user may select block “agent tax identification.” That is, the super administrator user 104 may select this option to add or delete, for example, an “agent tax identification” number from the blocking database 146. The “agent tax identification” may be used by the insurance entity 100 to identify agents, in accordance with one embodiment of the invention.

As a yet further menu option, in step 780 the super administrator user may select company registration. Step 780 might be followed by step 782 or step 784. In step 782 the super administrator user may update company registration. In step 784 the super administrator user may add company registration.

After processing any of menu options, the process passes to step 790. In step 790, the super administrator is provided with the option to select another menu item. If yes in step 790, the process returns to step 700. Alternatively, if no in step 790, then the process passes to step 792. In step 792 the process returns to step 640 of FIG. 8.

It should be appreciated that the menu options of FIGS. 8 and 9 are illustrative. Accordingly, the menu options for the super administrator and/or the general administrator may be varied and/or supplemented as desired.

As discussed above, FIG. 10 is a flowchart showing a “blocking portion performs processing” process in accordance with one embodiment of the invention. The processing of FIG. 10 might be performed by the blocking portion 128 working in conjunction with the blocking database 146, in accordance with one embodiment of the invention.

The blocking portion 128, in accordance with one embodiment of the invention, may perform a variety of functions. The blocking portion 128 may be implemented to block agents that a firm and/or agency, etc. does not wish to grant access to, i.e., who would otherwise be allowed access based on state licensing requirements, for example. That is, the particular agency may contact the insurance entity 100 requesting that the insurance entity 100 update the blocking database 146 to disallow access by such a disfavored agent. The blocking portion 128 also allows the insurance carrier, i.e., the insurance entity 100, to block (at their discretion) agents for either abuse or for other financial considerations. Such other considerations might be the amount or type of business being written not being economical for the insurance entity 100 to process, for example.

Returning to FIG. 10, the blocking process starts in step 800 and passes to step 802. In step 802, the agent validation portion 126 checks the submitted agent number against an approved agent list in the agent database 144, for example, in accordance with one embodiment of the invention. Then in step 804, the agent validation portion 126 determines if a match was found in the agent database 144. If no, then the process passes to step 820. In step 820, the blocking process is terminated with the conclusion that the agent 210 is not authorized, i.e., the session is terminated. Alternatively, if yes in step 804, then the process passes to step 806.

In step 806, the blocking portion 128, in accordance with one embodiment of the invention, checks the submitted agent number against a bad agent list stored in the blocking database 146. Then, in step 808 the process determines if any matches were identified in the agent number check. If yes, then the process passes to step 820. If no in step 808, then the process advances to step 812.

In step 812 the blocking portion 128 checks other submitted agent information against list of “problem criteria.” In step 814 the blocking portion 128 determines if any matches were identified in “problem criteria check”. If yes, then the process passes to step 820. If no in step 814, then the process proceeds to step 815.

In step 815, the process confirms that the agent's appointment status with the client is acceptable. That is, states of course maintain various requirements relating to activities of an agent vis-à-vis a client, and in particular, activities relating to solicitation prior to appointment. In accordance with one embodiment of the invention, the process may pose a series of questions to the agent regarding activities relating to the appointment, and compare the data obtained (from the agent's answers) to a particular state's requirements. If the appointment status is acceptable, the process passes to step 816. If the appointment status is not acceptable, the process passes to step 820, and the session is terminated, as described above.

In step 816 the blocking process is terminated with the determination that the agent is indeed authorized. Accordingly, the blocking processing, in accordance with one embodiment of the invention, may be used to provide a variety of checks on an agent attempting to interact with and use the insurance entity 100.

In accordance with one embodiment of the invention, FIG. 11 is a flowchart showing a “URL processing portion generates web page and outputs to web server” process. The processing of FIG. 11 may be performed by the URL processing portion 132, for example.

The process of FIG. 11 starts in step 900 and passes to step 910. In step 910, the URL processing portion 132 inputs a URL received from an agent 210 at an agency 200. Then the process passes to step 920, in which the URL processing portion 132 dissects the URL into what may be characterized as strings or string sets. Then, in step 930, the URL processing portion 132 assembles the web page data based on respective string sets.

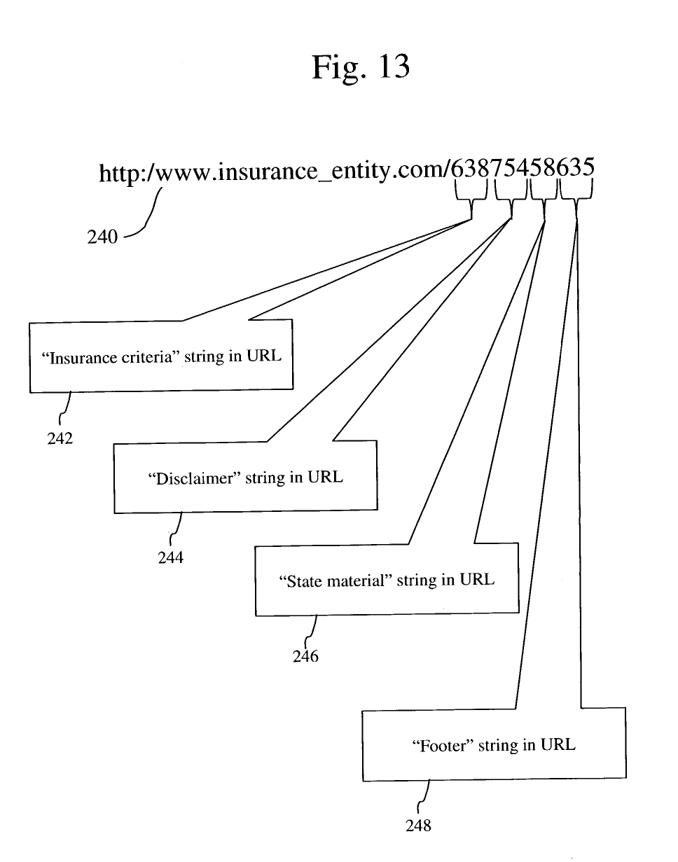

To explain further with reference to FIG. 13, FIG. 13 is a diagram showing a URL 240 in accordance with one embodiment of the invention. The URL 240 includes various strings (242, 244, 246, 248) in the address. The URL processing portion 132 dissects the URL into these strings and pulls data from various sources accordingly, i.e., based on the respective numbers in the strings (242, 244, 246, 248). In the example of FIG. 13, the respective strings represent insurance criteria, disclaimer information, state material information and footer information. The strings in the URL may be based on a variety of criteria as desired. For example, the footer string might be a particular agency's code, such that desired footer information may be presented to agents within that particular agency, i.e., when using the insurance tool 120. Accordingly, this manipulation of the URL by the URL processing portion 132 allows the content of pages generated by the insurance tool 120 to be readily changed by an administrator, for example, at the insurance entity 100, by changing the content of data in datastores from which the processing portion 132 pulls from, based on the URL.

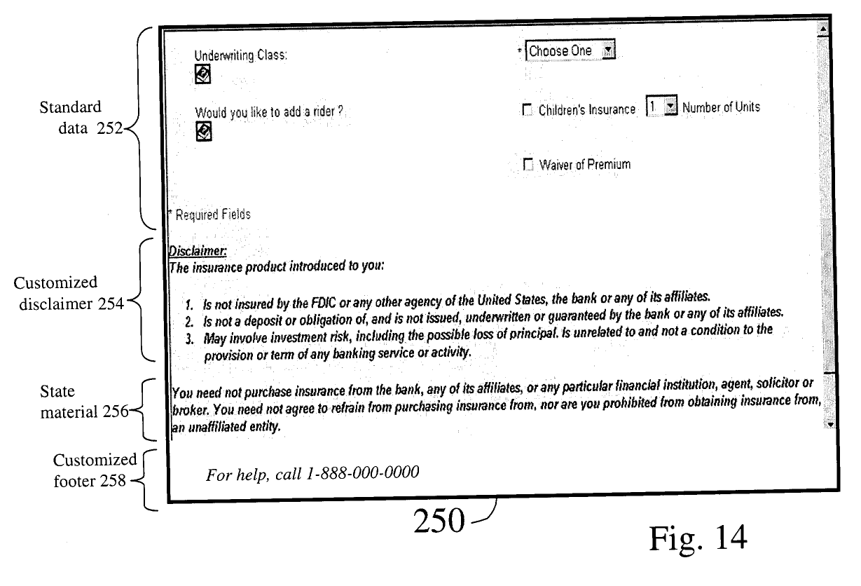

In further explanation, returning to FIG. 11, after step 930, the process passes to step 940. In step 940 the URL processing portion 132, working with the web interface portion 130, outputs a web page based on the URL received from the agent. In accordance with one embodiment of the invention, FIG. 14 is a user interface showing a generated screen shot 250. As shown in FIG. 14, the screen shot 250 shows data 252 that is generated from the insurance criteria string 242 in the URL 240, data 254 that is generated from the disclaimer string 244 in the URL 240, as well as data 256 that is generated from the “state material” string 246 in the URL 240. Further, the screen shot 250 shows data 258 that is generated from the “footer” string 248 in the URL 240. Accordingly, the data that is presented to an agent (in the form of a web page) by the insurance entity 100 may be pulled from a variety of databases and/or data sources and assembled by the URL processing portion 132 so as to output a web page to a user agent.

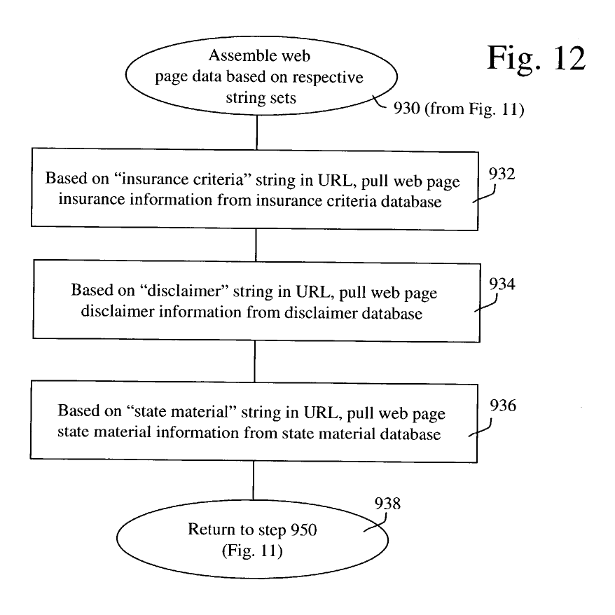

The processing of FIGS. 11 and 12 allows the customization of web pages the are presented to agents in their respective agencies. Any part of the presented web pages, such as the footers, for example, might use the customization feature provided by the URL processing described herein. In accordance with one embodiment of the invention, an agent may access the insurance tool 120, as described herein, with the appearance of being within their own agency's intranet. That is, the intranet of an agency 200 would pull requested web pages from the insurance tool 120 giving a user agent the appearance that he or she is still in their agency's own intranet. Accordingly, from an agent's perspective, the insurance tool 120 appears to be accessible from the agency's own site rather than forcing them to log into the insurance carriers site. This might be performed by an intranet of an agency 200, for example, (1) forwarding the URL (which is requested by an agent) to the insurance tool 120 and (2) accepting the responsive web page, which in turn is presented to the agent.

In accordance with one embodiment of the invention, the insurance tool 120 identifies the domain from which the tool is called, i.e., identifies what agency, for example, called the insurance tool 120. For example, the calling agency might automatically embed an identifier in the URL, which is sent from the agency 200 intranet to the insurance tool 120. The insurance tool 120, as a result, generates customized information (such as disclosures) based on the requesting domain. Further, since the insurance tool 120 is customizable by firm, it gives an agency more of an opportunity to co-brand with the insurance entity 100.

FIG. 12 is a flowchart showing the “assemble web page data based on respective string sets” step 930 of FIG. 11 in further detail in accordance with one embodiment of the invention. The subprocess of FIG. 12 starts in step 930 and passes to step 932.

In step 932, the URL processing portion 132, based on the “insurance criteria” string in the received URL, pulls web page insurance information from the insurance criteria database 152. Then, the process passes to step 934.

In step 934, the URL processing portion 132, based on “disclaimer” string in the URL, pulls web page disclaimer information from the disclaimer database. Further, in step 936, the URL processing portion 132, based on the “state material” string in the URL, pulls the web page state material information from a state material database. In step 938, the process returns to step 950 of FIG. 11. Any of a variety of other customized materials may be stored in suitable databases and used to generate a customized web page based on the dissected URL. Further, the systems and methods of the invention are not limited to specifically URLs. That is, some other type of Internet or network address might alternatively be used that is dissectible.

As described above, FIGS. 1 and 2 show one embodiment of the system of the invention. Further, FIGS. 3-13 show various steps of one embodiment of the method of the invention. The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above in the flowcharts. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including a microcomputer, mini-computer or mainframe for example, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the process of the invention.

It is appreciated that in order to practice the method of the invention as described above, it is not necessary that the processors and/or the memories of the processing machine be physically located in the same geographical place. That is, each of the processors and the memories used in the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Also, the invention may use any of a wide variety of known Internet and web page technology, such as servlet technology. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A system for providing insurance information from an insurance provider to a plurality of insurance agents disposed at respective insurance agent interface portions, the insurance agents working with respective clients, the system comprising:
an insurance entity that is in the business of providing insurance, the insurance entity including an insurance tool;
a first insurance agent interface portion, the insurance agent interface portion associated with a respective first insurance agent;
a second insurance agent interface portion, the insurance agent interface portion associated with a respective second insurance agent; and
a communication system that provides communication between the insurance tool and the insurance agent interface portion;
the first insurance agent interface portion inputs insurance request information from the first insurance agent and forwards the insurance request information to the insurance tool over the communication system, and in response, the insurance tool outputs first customized insurance information to the first insurance agent interface portion over the communication system; and
wherein the insurance tool generates the first customized insurance information based on dissecting internet address requests received from the first insurance agent interface portion.

2. The system of claim 1, wherein the communication system is the internet.

3. The system of claim 1, wherein the insurance request information from the first insurance agent interface portion is a request for an insurance quote, the insurance tool providing customized web pages to the first insurance agent based on dissecting the internet address requests so as to provide the insurance quote.

4. The system of claim 1, wherein the insurance request information from the first insurance agent interface portion is a request for an insurance quote, the insurance tool providing customized web pages to the first insurance agent based on dissecting the internet address requests so as to provide the insurance quote; and
wherein the insurance tool provides insurance quote information to the first insurance agent interface portion prior to performing an agent validation process; and
the insurance tool provides insurance plan information to the first insurance agent interface portion subsequent to performing an agent validation process.

5. The system of claim 1, wherein the insurance tool provides insurance quote information to the first insurance agent interface portion prior to performing an agent validation process, the insurance tool then converting the insurance quote information, after agent validation, to support an insurance plan.

6. The system of claim 5, wherein insurance plan information is forwarded to a fulfillment center subsequent to acceptance by the first insurance agent interface portion.

7. The system of claim 6, wherein the insurance tool logs the forwarding of the insurance plan information in a log data base, the log data base associated with the insurance tool.

8. The system of claim 1, wherein the insurance tool includes a blocking portion, the blocking portion performing a blocking process on the insurance request information received from the first insurance agent interface portion, the blocking process comparing data in the insurance request information with data in a blocking database associated with the insurance tool, the insurance tool terminating securement of an insurance plan by the first insurance agent interface portion if a match is determined.

9. The system of claim 8, wherein the blocking portion operates in conjunction with the first insurance agent performing a log-in process, the blocking portion comparing an agent number provided by the first insurance agent with a bad agent number list to identify a possible match.

10. The system of claim 8, wherein the blocking portion compares information regarding an appointment status, which is input by the first insurance agent, with acceptable appointment status criteria which is stored in the blocking database.

11. The system of claim 1, wherein the second insurance agent interface portion inputs insurance request information from the second agent and forwards the insurance request information to the insurance tool over the communication system, and in response, the insurance tool outputs second customized insurance information to the second insurance agent interface portion over the communication system; and
wherein the insurance tool generates the second customized insurance information based on dissecting internet address requests received from the second insurance agent interface portion, and wherein the internet address requests include a respective agency code identifying to which agency the second insurance agent belongs.

12. The system of claim 1, wherein the internet address requests received from the first insurance agent interface portion include an insurance criteria string, a disclaimer string and a state material string.

13. The system of claim 1, wherein the internet address requests received from the first insurance agent interface portion include a string of numbers that control the footer that is displayed in the first customized insurance information generated by the insurance tool, the footer being different for different agencies, the first customized insurance information being a generated web page.

14. The system of claim 2, wherein the first insurance agent interface portion is disposed on an intranet, and the intranet transmits URL requests from the first insurance agent interface portion to the insurance tool, the intranet further transmitting responsive web pages received from the insurance tool back to the first insurance agent interface portion.

15. The system of claim 14, wherein the intranet is maintained by an agency to which the first insurance agent belongs.

16. The system of claim 1, wherein a super administrator user and a general administrator user, who are associated with the insurance tool, change operating parameters of the insurance tool, the super administrator user having greater access rights as compared to the general administrator user.

17. The system of claim 16, wherein the super administrator updates state appointment requirements in a blocking database so as to monitor appointment criteria of the first insurance agent.

18. A system for providing insurance information from an insurance provider to a plurality of insurance agents disposed at respective insurance agent interface portions, the insurance agents working with respective clients, the system comprising:
an insurance entity that is in the business of providing insurance, the insurance entity including an insurance tool;
a first insurance agent interface portion, the insurance agent interface portion associated with a respective first insurance agent;
a second insurance agent interface portion, the insurance agent interface portion associated with a respective second insurance agent; and
a communication system that provides communication between the insurance tool and the insurance agent interface portion;
the first insurance agent interface portion inputs insurance request information from the first agent and forwards the insurance request information to the insurance tool over the communication system, and in response, the insurance tool outputs first customized insurance information to the first insurance agent interface portion over the communication system; and
wherein the insurance tool includes a blocking portion, the blocking portion performing a blocking process on the insurance request information received from the first insurance agent interface portion, the blocking process comparing data in the insurance request information with data in a blocking database associated with the insurance tool, the insurance tool terminating securement of an insurance plan by the first insurance agent interface portion if a match is determined.

19. The system of claim 18, wherein the blocking portion operates in conjunction with the first insurance agent performing a log-in process, the blocking portion comparing an agent number provided by the first insurance agent with a bad agent number list to identify a possible match.

20. The system of claim 18, wherein the blocking portion compares information regarding an appointment status, which is input by the first insurance agent, with acceptable appointment status criteria which is stored in the blocking database.

21. A system for providing insurance information from an insurance provider to a plurality of insurance agents disposed at respective insurance agent interface portions, the insurance agents working with respective clients, the system comprising:
an insurance entity that is in the business of providing insurance, the insurance entity including an insurance tool;
a first insurance agent interface portion, the insurance agent interface portion associated with a respective first insurance agent;
a second insurance agent interface portion, the insurance agent interface portion associated with a respective second insurance agent; and
a communication system that provides communication between the insurance tool and the insurance agent interface portion;
the first insurance agent interface portion inputs insurance request information from the first agent and forwards the insurance request information to the insurance tool over the communication system, and in response, the insurance tool outputs first customized insurance information to the first insurance agent interface portion over the communication system; and
wherein the insurance tool generates the first customized insurance information based on dissecting internet address requests received from the first insurance agent interface portion; and
wherein the insurance tool includes a blocking portion, the blocking portion performing a blocking process on the insurance request information received from the first insurance agent interface portion, the blocking process comparing data in the insurance request information with data in a blocking database associated with the insurance tool, the insurance tool terminating securement of an insurance plan by the first insurance agent interface portion if a match is determined.

22. A method for providing insurance information from an insurance provider to a plurality of insurance agents disposed at respective insurance agent interface portions, the insurance agents working with respective clients, the method comprising:
providing an insurance entity that is in the business of providing insurance, the insurance entity including an insurance tool;
providing a first insurance agent interface portion, the insurance agent interface portion associated with a respective first insurance agent;
providing a second insurance agent interface portion, the insurance agent interface portion associated with a respective second insurance agent; and
providing a communication system that provides communication between the insurance tool and the first insurance agent interface portion;
inputting, by the first insurance agent interface portion, insurance request information from the first agent;
forwarding the insurance request information to the insurance tool over the communication system using an internet address request, and in response;
outputting, by the insurance tool, first customized insurance information to the first insurance agent interface portion over the communication system; and
wherein the insurance tool generates the first customized insurance information based on dissecting the internet address request received from the first insurance agent interface portion.

23. The method of claim 22, further including the insurance tool performing a blocking process including:
comparing data in the insurance request information with data in a blocking database associated with the insurance tool; and
terminating securement of an insurance plan by the first insurance agent interface portion if a match is determined.

24. A method for providing insurance information from an insurance provider to a plurality of insurance agents disposed at respective insurance agent interface portions, the insurance agents working with respective clients, the method comprising:
providing an insurance entity that is in the business of providing insurance, the insurance entity including an insurance tool;
providing a first insurance agent interface portion, the insurance agent interface portion associated with a respective first insurance agent;
providing a second insurance agent interface portion, the insurance agent interface portion associated with a respective second insurance agent; and
providing a communication system that provides communication between the insurance tool and the first insurance agent interface portion;
inputting, by the first insurance agent interface portion, insurance request information from the first insurance agent;
forwarding the insurance request information to the insurance tool over the communication system using an internet address request, and in response;
outputting, by the insurance tool, first customized insurance information to the first insurance agent interface portion over the communication system; and
wherein the insurance tool generates the first customized insurance information based on dissecting the internet address request received from the first insurance agent interface portion; and;
comparing data in the insurance request information with data in a blocking database associated with the insurance tool; and
terminating securement of an insurance plan by the first insurance agent interface portion if a match is determined between data in the insurance request information and data in a blocking database.
